(19) United States
(12) Patent Application Publication
(10) Pub. No.: US 2023/0237288 A1
(43) Pub. Date: Jul. 27, 2023

(54) RFID READER FOR SMART PHONE BY MAGNETIC CONNECTION

(71) Applicant: MARSON TECHNOLOGY CO., LTD., New Taipei City (TW)

(72) Inventor: KUO-SHEN LIU, New Taipei City (TW)

(21) Appl. No.: 17/834,926

(22) Filed: Jun. 7, 2022

Related U.S. Application Data
(63) Continuation-in-part of application No. 17/580,656, filed on Jan. 21, 2022.

(51) Int. Cl. G06K 7/10; H01R 13/24; G06F 13/42

(52) U.S. Cl. CPC G06K 7/10386; G06K 7/10297; H01R 13/2421; G06F 13/4282; G06F 2213/0042

(57) ABSTRACT

A RFID reader magnetically attachable to a smart phone includes a circuitry adaptor and a RFID access device. The circuitry adaptor is plugged into a USB connector of the smart phone. The RFID access device is magnetically and detachably connected to the circuitry adaptor, so that electricity and signals from the smart phone are transmitted to the RFID access device, and RFID tag signals picked up by the RFID access device are transmitted to the smart phone. When the RFID access device undergoes external impact, the circuitry adaptor and the RFID access device are detached from each other without damaging the USB connectors.

### CROSS-REFERENCE TO RELAYED APPLICATION

The present application is a continuation-in-part of U.S. patent application Ser. No. 17/580,656, filed on Jan. 21, 2022, which is herein incorporated by reference in its entirety.

### BACKGROUND OF THE INVENTION

### (a) Technical Field of the Invention

The present invention is generally related to RFID readers, and more particular to a RFID reader fitted on a smart phone by magnetic connection.

### (b) Description of the Prior Art

A radio-frequency identification (RFID) system includes RFID readers and RFID tags. A RFID reader includes control elements and antenna. A RFID tag has a chip for storing/processing data and an antenna for transmitting/receiving signals. When the RFID tag detects a signal from the RFID reader, it transmits its stored data to the RFID reader. The chip of the RFID tag is powered by electrical current induced the radio wave from the RFID reader through electromagnetic induction. There are active and passive RFID tags. A passive RFID tag does not have a battery and is powered entirely be the electromagnetically induced current. Therefore, a passive RFID tag does not respond to a RFID reader until it has received a signal from the RFID reader. On the other hand, an active RFID reader has a built-in battery and, therefore, may transmit its data proactively to the RFID reader and for a greater distance than a passive RFID tag. The stored data of an RFID tag may be read-only, or it may be appended or overwritten by new data.

Compared to the barcode system, RFID has at least the following advantages.

First, once a barcode is printed, it cannot be changed. In contrast, the data stored in a RFID tag may be repeatedly appended, modified, and deleted.

Second, a barcode has to be scanned in close distance and without blocking the scanning light. On the other hand, an RFID tag can be accessed conveniently, as long as it is within radio wave coverage.

Third, A barcode scanner can only one barcode at a time. A RFID reader may access multiple RFID tags simultaneously.

Fourth, RFID is more secured as the RFID tag is more difficult to falsity and alternate. The printed barcode is easier to duplicate.

As such, even though RFID involves a higher cost, RFID is commonly applied in scenarios requiring efficiency and security such as factory inventory control, logistics and transportation management, etc.

As shown in FIG. 1, a conventional portable RFID reader includes a main member 5 on which a button 51 activates the RFID reader to access RFID tag 52. The RFID reader also includes Bluetooth deice 53 for connection with an Android or iOS mobile device 54, a battery 55, an indicator lamp 56, etc. This RFID reader requires multiple components to operate along with the mobile device 54, which is costlier and less convenient.

FIG. 2 depicts another conventional RFID reader, which includes a main member 6 having a USB male plug 61. A smart phone 7 is turned into a mobile RFID reader when the RFID reader is joined to the smart phone 7 by plugging the USB male plug 61 into a USB female socket 71 of the smart phone 7. Through the USB female socket 71, the smart phone 7 transmits control signals and power to the main member 6. The main member 6 transmits received RFID tag data to the smart phone 7 through the USB male plug 61. This design utilizes the ubiquity of the smart phone 7, which has a sizable display 72. However, it suffers a disadvantage that, when the RFID reader is hit, the USB male plug 61 is often fractured or the USB female socket 71 is damaged.

### SUMMARY OF THE INVENTION

A major objective of the present invention is to provide a RFID reader that is magnetically attached to a smart phone so that, under external impact, the USB connectors of the RFID reader and the smart phone are not damaged.

The RFID reader includes a circuitry adaptor and a RFID access device. The circuitry adaptor is plugged into a USB connector of the smart phone. The RFID access device is magnetically and detachably connected to the circuitry adaptor, so that electricity and signals from the smart phone are transmitted to the RFID access device, and RFID tag signals picked up by the RFID access device are transmitted to the smart phone. When the RFID access device undergoes external impact, the circuitry adaptor and the RFID access device are detached from each other without damaging the USB connectors.

The circuitry adaptor further includes a magnet and a USB male connector on a front side for connecting a USB female connector of the smart phone. The USB male connector has a number of contacts configured on a side of the circuitry adaptor opposite to the USB male connector and electrically connected to the USB male connector.

The RFID access device has a magnetic part on a front side. The magnetic part has a number of chambers respectively housing an equal number of the pogo pins. The pogo pins has their tips extruding out of a front side of the magnetic part, and the pogo pins are electrically connected to a circuit of the RFID access device.

The magnetic part of the RFID access device includes a magnet.

The magnet of the circuitry adaptor has a polarity opposite to that of the magnetic part of the RFID access device.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective diagram showing a conventional RFID reader.

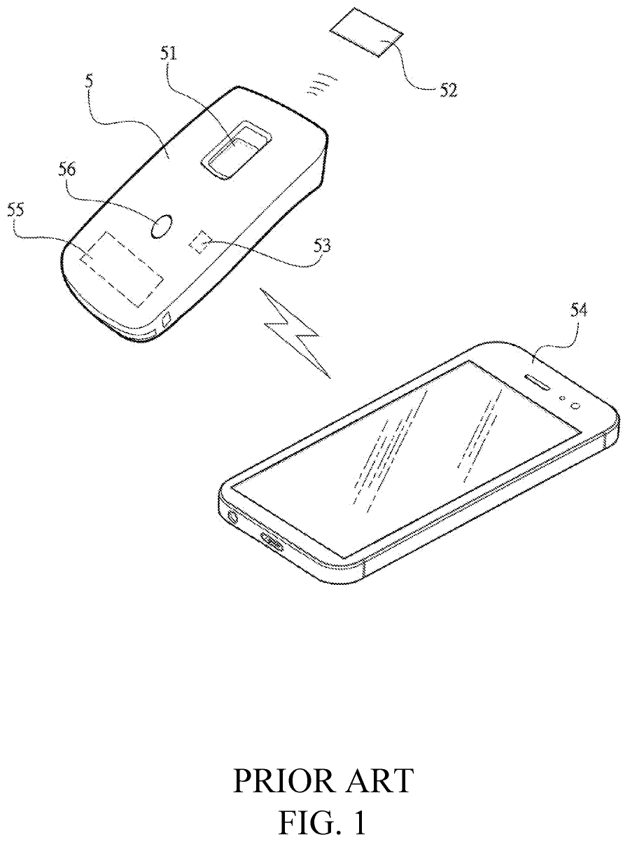

FIG. 2 is a perspective diagram showing another conventional RFID reader.

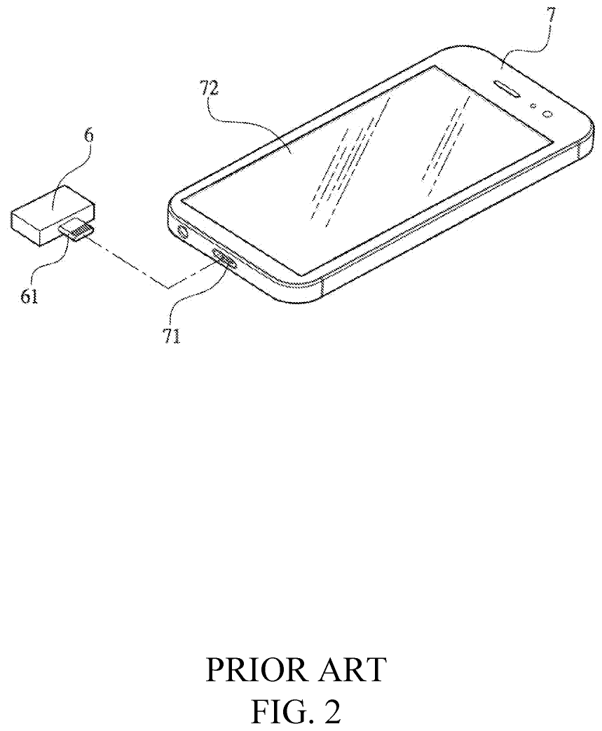

FIG. 3 is a perspective breakdown diagram showing a RFID reader according to a first embodiment of the present invention.

FIG. 4 is a perspective diagram showing the RFID reader of FIG. 3.

FIG. 5 is a schematic top view diagram showing the RFID reader of FIG. 3.

FIG. 6 is a perspective diagram showing how a smart phone is charged through a circuitry adaptor of the RFID reader of FIG. 3.

FIG. 7 is a perspective breakdown diagram showing a RFID reader according to a second embodiment of the present invention.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

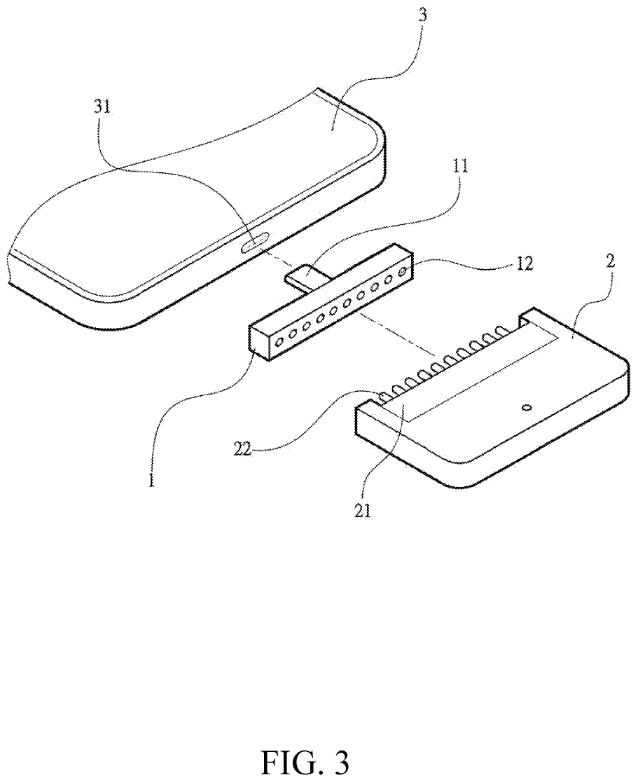

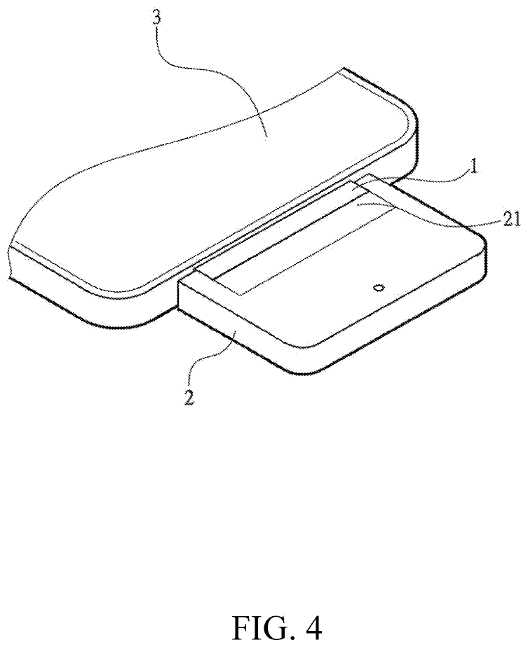

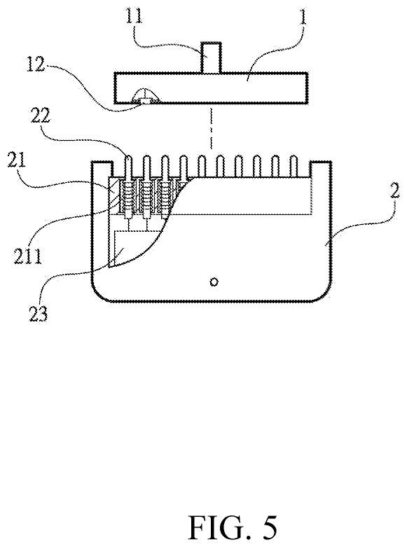

As shown in FIG. 3, FIG. 4, and FIG. 5, a RFID reader according to a first embodiment of the present invention includes a circuitry adaptor 1 and a RFID access device 2. The circuitry adaptor 1 includes a USB male connector 11, and a number of contacts 12 configured on a side of the circuitry adaptor 1 opposite to the USB male connector 11. The USB male connector 11 is electrically connected to the contacts 12. In the present embodiment, the circuitry adaptor 1 includes a magnet.

The RFID access device 2 includes a RFID circuit 23 inside with control elements, antenna, etc. for accessing RFID tags. The RFID access device 2 has a magnetic part 21 on a front end, and the magnetic part 21 has a number of chambers 211 (as shown in FIG. 5) respectively housing an equal number of pogo pins 22 where the pogo pins 22 have their tips extruding out of the magnetic part 21's front side. The pogo pins 22 are electrically connected to the RFID circuit 23 inside the RFID access device 2. The magnetic part 21 is magnetized or includes a magnet with a polarity opposite to that of the magnet inside the circuitry adaptor 1. The two therefore attract each other.

To use the RFID reader, the USB male connector 11 of the circuitry adaptor 1 is first plugged into a USB female connector 31 of a smart phone 3. Then, the RFID access device 2 is placed adjacent to the circuitry adaptor 1, where the two are joined together by the mutual magnetic attraction between the circuitry adaptor 1 and the magnetic part 21. The pogo pins 22 as such are contacted with and conducted to the contacts 12. In addition, due to the elasticity of pogo pins 22, they are pressed against the contacts 12 by their elasticity, thereby securing the electrical connection. Electricity and control signals from the smart phone 3 are transmitted to the RFID access device 2 through the pogo pins 22, while RFID tag signals picked up by the RFID access device 2 are transmitted to the smart phone 3 also via the pogo pins 22. As such and as shown in FIG. 4, the smart phone 3 becomes a mobile RFID reader applicable to various scenarios. When the RFID access device 2 undergoes external impact, circuitry adaptor 1 and the magnetic part 21 are detached, without damaging the USB male connector 11 of the circuitry adaptor 1 or the USB female connector 31 of the smart phone 3. By placing the RFID access device 2 again around the circuitry adaptor 1, the RFID access device 2 restores its connection with the circuitry adaptor 1 automatically, resolving the problems suffered by conventional RFID readers.

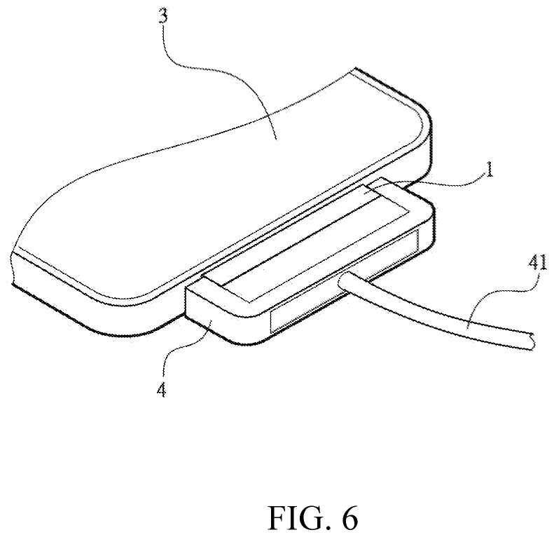

As shown in FIG. 6, to charge the smart phone 3 equipped with the circuitry adaptor 1, a charging adaptor 4 is magnetically attached to the circuitry adaptor 1 and a cable 41 of the charging adaptor 4 is connected to a power source (not shown) so as to charge the smart phone 3. Of course, it is also possible to remove the circuitry adaptor 1 from the smart phone 3 and the smart phone 3 may be charge through conventional means.

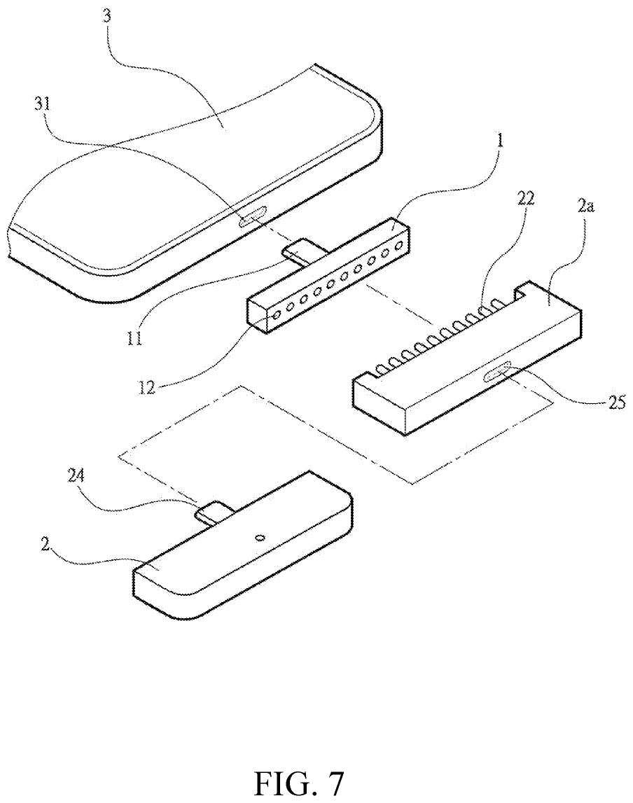

As shown in FIG. 7, a RFID reader according to a second embodiment of the present invention further includes a second circuitry adaptor 2a. The second circuitry adaptor 2a includes the pogo pins 22 as in the previous embodiment and has a USB female connector 25 on a back side while the RFID access device 2 of the present embodiment has a USB male connector 24 on a front side. The RFID access device 2 and the second circuitry adaptor 2a are coupled together by plugging the USB male connector 24 into the USB female connector 25, thereby forming an integrated RFID access device 2 as shown in FIG. 3. The advantage of the present embodiment is that it is easier to manufacture, but the disadvantage is that more material is involved.

As described above, the gist of the present invention lies in the separation of a RFID reader into a magnetic circuitry adaptor and a RFID access device. The magnetic means coupling the RFID reader and a smart phone prevent the possible damage to their USB connectors from external impact.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the claims of the present invention.

I claim:

1. A RFID reader for a smart phone by magnetic connection, comprising a circuitry adaptor and a RFID access device, wherein
the circuitry adaptor is for connection to the smart phone;
the RFID access device is magnetically and detachably connected to the circuit adaptor;
the circuit adaptor comprises a plurality of contacts and the RFID access device correspondingly comprises a plurality of pogo pins for establishing electrical connection with the contacts; and
electricity and signals from the smart phone are transmitted to the RFID access device, and RFID tag signals picked up by the RFID access device are transmitted to the smart phone, both through the pogo pins and the contacts.

2. The RFID reader according to claim 1, wherein the circuit adaptor further comprises a magnet and a USB male connector for connecting to a USB female connector of the smart phone; the contacts are configured on a side of the circuit adaptor opposite to the USB male connector and electrically connected to the USB male connector; the RFID access device further comprises a magnetic part for magnetically and detachably attached to the circuitry adaptor; and the pogo pins are housed in the magnetic part.

3. The RFID reader according to claim 2, wherein the magnetic part has a plurality of chambers respectively housing an equal number of the pogo pins; the pogo pins have their tips extruding out of a front side of the magnetic part; and the pogo pins are electrically connected to a circuit of the RFID access device.

4. The RFID reader according to claim 1, wherein a front part of the RFID access device is separated into an independent second circuitry adaptor; the second circuitry adaptor has a USB female connector on a back side; and the RFID access device further comprises a USB male connector for plugging into the USB female connector of the second circuitry adaptor, thereby forming the RFID access device as claimed in claim 1.

5. The RFID reader according to claim 2, wherein the magnet of the circuitry adaptor has a polarity opposite to that of the magnetic part of the RFID access device.
